(19) United States
(12) Patent Application Publication
(10) Pub. No.: US 2010/0333070 A1
(43) Pub. Date: Dec. 30, 2010

(54) Multiple ECU Software-In-The-Loop Simulation Environment

(75) Inventor: Jared M. Farnsworth, Sacramento, CA (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/492,710

(22) Filed: Jun. 26, 2009

(51) Int. Cl. G06F 9/44; G06F 12/00; G06F 12/02

(52) U.S. Cl. 717/128; 711/170; 717/104; 711/E12.001; 711/E12.002

(57) ABSTRACT

The invention relates to methods for evaluating the performance of a system having a plurality of electronic control unit (ECU) software programs. A plurality of first memory spaces are allocated for use by the software programs. At least one second memory space is allocated to be in communication with these first memory spaces. The output of at least one first software program is stored in at least one of said first memory spaces associated with that program, wherein said output is subsequently transmitted to at least one said second memory space, and wherein said output is further subsequently transmitted to at least one of said first memory spaces associated with at least one second software program. From this location, said output is accessed as an input for said second software program. The performance of the system is evaluated by executing said software programs and determining if the outputs of said programs satisfy the criteria of the system.

### FIELD OF THE INVENTION

The invention relates to a method for simulating the performance of a vehicle comprising a plurality of electronic control units (ECUs) and, in particular, a method for simulating the performance of a vehicle comprising a plurality of interdependent ECUs.

### BACKGROUND OF THE INVENTION

Modern day automotive vehicles comprise an increasingly large number of electronic subsystems. The operation of each of these subsystems is typically regulated by an electronic control unit (ECU). A typical vehicle may include ECUs such as an engine control unit, a transmission control unit, a seat control unit, and a climate control unit, among many others. Each ECU is capable of sending control signals to the subsystem that it is regulating, as well as receiving information back from this subsystem. Each ECU typically comprises a processor embedded with algorithms for generating the appropriate control signals. Increasingly, these algorithms include as inputs, the outputs of a different ECU. For example, the engine control unit may require the output of the transmission control unit before being able to generate its own control signals. This increasing integration of electronic subsystems poses a problem for the software developers responsible for programming, validating and testing the software embedded in the various ECUs. Presently, Software-in-the-Loop (SIL) simulations may be used to evaluate the performance of the electronic control unit algorithms. SIL simulations allow for software design to occur before the production of an actual prototype of the ECU hardware. This hardware is instead simulated by a variety of computer models. It is desirable to have an efficient method of conducting such an SIL simulation on a vehicle comprising a plurality of interdependent ECUs, within a single simulation environment.

### SUMMARY OF THE INVENTION

The invention relates to methods for evaluating the performance of a system having a plurality of electronic control unit (ECU) software programs. A plurality of first memory spaces are allocated for use by the software programs. At least one second memory space is allocated to be in communication with these first memory spaces. The output of at least one first software program is stored in at least one of said first memory spaces associated with that program, wherein said output is subsequently transmitted to at least one said second memory space, and wherein said output is further subsequently transmitted to at least one of said first memory spaces associated with at least one second software program. From this location, said output is accessed as an input for said second software program. The performance of the system is evaluated by executing said software programs and determining if the outputs of said programs satisfy the criteria of the system.

Further embodiments of the invention may also comprise a variety of other models interacting with the ECU software programs. The outputs of these models may be used as inputs to the ECU software programs and the outputs of the ECU software programs may be used as inputs to these models.

The invention allows a user to simulate the entire performance and driving experience of a vehicle without any of the physical hardware associated with the vehicle. The invention allows for various models and software programs to interact together and share outputs and parameters, so as to generate a dynamic representation of the vehicle.

### BRIEF DESCRIPTION OF THE DRAWINGS

FIG. 1 is a chart of the various steps executed to allow for the sharing of variables and parameters between various ECU control programs;

FIG. 2 is an illustration of an example implementation of the SIL simulation.

### DETAILED DESCRIPTION OF THE PREFERRED EMBODIMENTS

The present invention has utility in improving the design process of electronic control units. While the present invention is discussed hereafter in the context of an automotive control system, this is not intended to be a limitation upon the use thereof but rather to afford an intuitive and illustrative usage setting. The system can indeed be used in the design process of any system comprising a plurality of electronic control units.

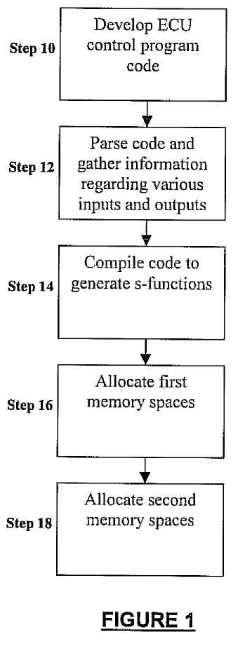

Referring now to FIG. 1, at step 10, ECU control programs have been developed for a plurality of different ECUs. These programs may be written in any one of a number of programming languages, including but not limited to C. These programs can be thought of as each comprising three different segments: the application code, the communication code, and the scheduler code. While there is no such actual division of the programs, the distinction has been made for illustrative purposes to describe the programs' various functionalities. The application code is that code which is used for the actual control of the electronic subsystem being regulated. It contains the algorithms that are used to generate the control signals. The communication code is used for communicating with other ECU control programs, and various blocks of memory. This includes any low level serial, CAN, and sensor I/O communication code. The scheduler code controls the timing of various software operations, including but not limited to the transmission and reception of updated variables.

At step 12, the code is parsed and all inputs and outputs of the various ECU control programs are determined. These inputs may include the outputs of various physics models, which, for example, may be used to simulate the vehicle's external driving environment. The inputs may further include the outputs of various plant models. The plant models simulate the behavior and changing properties of the various hardware components present in the vehicle. For example, a plant model may be used to simulate the properties and behavior of an engine, a battery, or an HVAC system. The plant models may also be used to simulate the general vehicle dynamics, including changing velocities and accelerations. A plant model may also be used to simulate the actions of a driver, and various driver behaviors. The inputs may also include the outputs of other ECU control programs. For example, the engine control unit may require the output of the transmission control unit before being able to generate its own control signals. While the above three categories of inputs have been enumerated, other types of inputs including, but not limited to, sensor outputs or control logic parameters may also be required. Alternatively, test vectors may be used instead of the above described plant models and physics models.

At step 14, the code of the various control programs is compiled to form a plurality of executable programs referred to as s-functions. The s-functions can be executed using a variety of commercially available programs, including MATLAB, made by The Mathworks, Inc. of Natick, Mass. In practice, step 12 and step 14 may occur simultaneously or in reverse order. At step 167 each s-function is allocated one of a plurality of first memory spaces. In this memory space, each s-function can store local copies of the various variables and parameters that it uses. In one embodiment of the invention, each s-function is allocated its own unique first memory space. This first memory space will hereafter be referred to as the local memory. This name does not serve to describe any properties of the memory, rather it is merely a label by which to refer to it and distinguish it from a second memory space described below. In practice, step 16 may be executed by the software, such as MATLAB, that is being used to run the s-functions, and may also occur simultaneously with step 14.

At step 18, at least one second memory space is allocated. At least one of each s-function's said first memory spaces is associated with at least one said second memory space. In one embodiment of the invention, each s-function is allocated its own unique first memory space, each of which is associated with a unique said second memory space allocation. In a different embodiment fewer said second memory spaces may be allocated.

As will be explained below, in further detail, the second memory space serves to act as a buffer where variables can be stored and/or updated before being transmitted to the first memory space for use by the s-function, or possibly before being transmitted to a plant model or physics model. This second memory allocation will hereafter be referred to as a buffer memory. Again, this name does not serve to describe any properties of the memory, rather it is merely a label by which to refer to it and distinguish it from the first memory allocation described above. The execution of the above describe steps enables the simulation to be run. In practice, these steps may be executed before running the simulation, or at the beginning stages of the simulation.

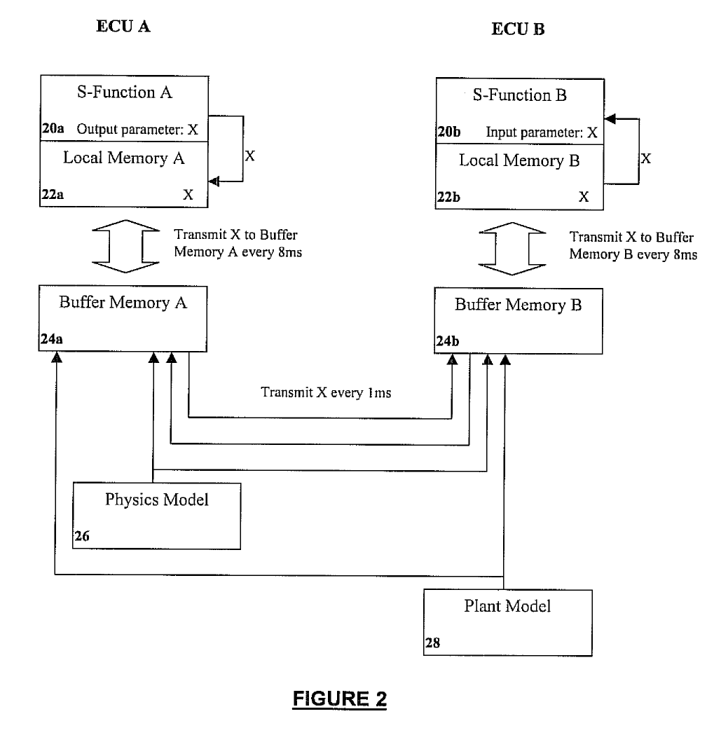

FIG. 2 illustrates an example implementation of the simulation. The example is of the earlier described embodiment, wherein each s-function is allocated its own unique first memory space, each of which is associated with a unique said second memory space allocation. For illustrative purposes, this example has been simplified to a system comprising two ECUs, however it is understood that the simulation could be used for a system with any number of ECUs. Also, the system has been simplified so that the output of the plant models and physics models are not dependent on the outputs of the ECU s-functions. Again, it is understood that the simulation could be used for a system where these models are dependent on the output of the ECU s-functions. In the same method, as will be described below, in which a first ECU s-function is able to access the output of a second ECU s-function, a plant model or physics model could also be configured to access an ECU s-function output, if so needed.

In this example, the system comprises two ECUs, ECU A and ECU B. At step 10, control programs have been written for both of these ECUs, and at step 12, these programs have been compiled into s-function A and s-function B respectively. S-function A 20a has been allocated a unique first memory space, local memory A 22a. Local memory A, in turn, is associated with a second memory space allocation, buffer memory A, 24a. Similarly, S-function B 20b has been allocated a unique first memory space, local memory B 22b, which is in turn associated with a second memory space allocation, buffer memory B, 24a. The juxtaposing of the s-function and local memory in FIG. 2 is for illustrative purposes and represents the strong association of the s-function has with the local memory. The s-function is simply a compiled version of the control program code, and the local memory is used during mm-time to execute its various operations.

Local memory A 22a is in communication with buffer memory A 24a and local memory B 22b is in communication with buffer memory B 24b. The local memory and the buffer memory are able to transmit and receive variables to and from each other through the use of the above-mentioned communication code. Physics model 26 and plant model 28 are also in communication with buffer memories 24a and 24b.

The flow chart illustrates how variables may be shared by two ECU control programs. Suppose s-function B needs to access parameter X of the output of s-function A. S-function A is programmed to store the value of parameter X in local memory A 22a. This output is calculated intermittently, for example, every 8 ms, as determined by the scheduler code. The communication code then allows for the transmission of this value to buffer memory A 24a. In the context of this invention, the term “transmission” refers to the sharing of the object being “transmitted”. In this case it means that the value of parameter X is copied from local memory A 22a, and written to buffer memory A 24a.

Since during step 12, parameter X has already been determined to be a global input, it is read from buffer memory A 24a and written to buffer memory B 24b. The transmission of any variables from buffer memory A 24a to buffer memory B 24b also occurs intermittently, for example, every 1 ms. When the scheduler code of s-function B 20b determines it is ready to access parameter X, the communication code retrieves a copy of it from buffer memory B 24b and stores it in local memory B 22b. Here the s-function now has direct access to it, and can call on it when required, for example, every 8 ms. In a similar manner to the process described above, s-function A 20a can gain access to parameters of the output of s-function B 20b. Also in a similar manner, the physics models and plant models can gain access to the parameters of an s-function output, after they have been stored in the appropriate buffer memory. The performance of the system is evaluated by executing the s-functions and various models and determining if the outputs of the s-functions and models satisfy the criteria of the system.

Simultaneous to the above-described process in which variables are being shared by multiple ECU control programs, the physics models and plant models are also outputting values. These values are being calculated and updated by the models on a time schedule that may be different from that of the s-functions. Thus, the outputs of these models is written to the appropriate buffer memories, from where they can be transmitted to the local memory, and accessed by the s-functions at the appropriate time. It can be seen then, that the buffer memory does indeed serve as a sort of buffer. While different ECU s-functions and various models may be running simultaneously, they each may be running on their own schedule, and outputting results at different rates. A problem could occur, for example, if s-function A is using parameter X of s-function B, and before s-function A has finished making its calculation, s-function B updates the value of parameter X. This is one reason why parameter X is first sent to buffer memory A, rather than directly to local memory A. In this method, s-function A can finish making its calculation using the value of parameter X previously written to local memory A, and call on the updated value of parameter X from buffer memory A when it is ready.

In this manner, a realistic simulation of a vehicle can be conducted without the use of any vehicular hardware. Models are used to simulate various vehicle components such as the battery and engine. Models are also used to simulate the external driving environment, and the driver behavior. These models provide a dynamic setting under which the performance of the ECU control software can be evaluated. The outputs of the ECU s-functions can be monitored, and if there is a problem, the algorithms can be tweaked and the simulation can be run again. The robustness of the system can be increased by using different models. For example, the driver model can be replaced by a driver model representing a drowsy or intoxicated driver, and the simulation can be rerun to ensure that the appropriate control signals are generated in this new scenario.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims including all equivalents which define the scope of the invention.

I claim:

1. A method for evaluating the performance of a system having a plurality of electronic control unit (ECU) software programs, the method comprising:
allocating a plurality of first memory spaces, wherein each software program is associated with at least one of said first memory spaces;
allocating at least one second memory space, wherein at least one of each software program's said first memory spaces is associated with at least one said second memory space;
storing at least one output of at least one first software program in at least one of said first memory spaces associated with that program, subsequently transmitting said output to at least one said second memory space, further subsequently transmitting said output to at least one of said first memory spaces associated with at least one second software program, and accessing said output as an input for said second software program; and
evaluating whether the outputs of said software programs meet performance criteria;

2. The method of claim 1 wherein each software program is associated with one unique said first memory space.

3. The method of claim 1 comprising allocating a plurality of second memory spaces, wherein at least one of each software program's said first memory spaces is associated with at least one of said second memory spaces.

4. The method of claim 1 wherein each software program is associated with one unique said first memory space, the method comprising:
allocating a plurality of second memory spaces, wherein each software program's said first memory space is associated with one unique said second memory space.

5. The method of claim 4 comprising:
storing at least one output of at least one first software program in said first memory space associated with that program;
subsequently transmitting said output to said second memory space associated with said first memory space associated with said first software program;
further subsequently transmitting said output to said second memory space associated with said first memory space associated with a second software program;
further subsequently transmitting said output to said first memory space associated with said second software program; and
accessing said output as an input for said second software program;

6. The method of claim 1 wherein said first and second memory spaces are allocated before said software programs are executed.

7. The method of claim 1 wherein said first and second memory spaces are allocated at the time said software programs are executed.

8. The method of claim 1 wherein said first and second memory spaces are allocated after said software programs are executed.

9. The method of claim 1 comprising running at least one model, wherein the model is a plant model or a physics model.

10. The method of claim 1 comprising running at least one test vector.

11. The method of claim 9 wherein at least one output of at least one said model is used as an input to at least one of said software programs.

12. The method of claim 9 wherein at least one output of at least one of said software programs is used as an input to at least one of said models.

13. The method of claim 9 comprising storing at least output of at least one of said models in at least one of said second memory spaces, subsequently transmitting said output to at least one of said first memory spaces associated with at least one software program, and accessing said output as an input for said software program.

14. The method of claim 9 comprising storing at least one output of at least one of said software programs in at least one of said first memory spaces associated with that program, subsequently transmitting said output to at least one of said second memory space, and accessing said output as an input for at least one of said models.

15. The method of claim 1 wherein the system comprises an automotive vehicle having a plurality of electronic control units.

16. The method of claim 1 wherein the system comprises an automotive vehicle control system.

17. A method for the design and testing of electronic control unit (ECU) software programs, the method comprising:
(a) allocating a plurality of first memory spaces, wherein each software program is associated with at least one of said first memory spaces;
(b) allocating at least one second memory space, wherein at least one of each software program's said first memory spaces is associated with at least one said second memory space;
(c) storing at least one output of at least one first software program in at least one of said first memory spaces associated with that program, subsequently transmitting said output to at least one said second memory space, further subsequently transmitting said output to at least one of said first memory spaces associated with at least one second software program, and accessing said output as an input for said second software program;
(d) evaluating the performance of the software programs by determining if the outputs of said software programs meet performance criteria;
(e) rewriting at least a portion of at least one software program if the outputs of any software program do not meet performance criteria, and subsequently repeating steps (a) through (d)

18. The method of claim 17 wherein each software program is associated with one unique said first memory space.

19. The method of claim 17 comprising allocating a plurality of second memory spaces, wherein at least one of each software program's said first memory spaces is associated with at least one of said second memory spaces.

20. The method of claim 17 wherein each software program is associated with one unique said first memory space, the method comprising:
allocating a plurality of second memory spaces, wherein each software program's said first memory space is associated with one unique said second memory space.

21. The method of claim 20 comprising:
storing at least one output of at least one first software program in said first memory space associated with that program;
subsequently transmitting said output to said second memory space associated with said first memory space associated with said first software program;
further subsequently transmitting said output to said second memory space associated with said first memory space associated with a second software program;
further subsequently transmitting said output to said first memory space associated with said second software program; and
accessing said output as an input for said second software program;

22. The method of claim 17 wherein said first and second memory spaces are allocated before said software programs are executed.

23. The method of claim 17 wherein said first and second memory spaces are allocated at the time said software programs are executed.

24. The method of claim 17 wherein said first and second memory spaces are allocated after said software programs are executed.

25. The method of claim 17 comprising running at least one model, wherein the model is a plant model or a physics model.

26. The method of claim 17 comprising running at least one test vector.

27. The method of claim 25 wherein at least one output of at least one said model is used as an input to at least one of said software programs.

28. The method of claim 25 wherein at least one output of at least one of said software programs is used as an input to at least one of said models.

29. The method of claim 25 comprising storing at least output of at least one of said models in at least one of said second memory spaces, subsequently transmitting said output to at least one of said first memory spaces associated with at least one software program, and accessing said output as an input for said software program.

30. The method of claim 25 comprising storing at least one output of at least one of said software programs in at least one of said first memory spaces associated with that program, subsequently transmitting said output to at least one of said second memory space, and accessing said output as an input for at least one of said models.

31. The method of claim 17 wherein the system comprises an automotive vehicle having a plurality of electronic control units.

32. The method of claim 17 wherein the system comprises an automotive vehicle control system.

33. A method for evaluating the performance of a system having a plurality of electronic control unit (ECU) software programs, the method comprising:
allocating a plurality of first memory spaces, wherein each software program is associated with one unique said first memory spaces;
allocating a plurality of second memory spaces, wherein each software program's said first memory space is associated with one unique said second memory space.
storing at least one output of at least one first software program in said first memory space associated with that program;
subsequently transmitting said output to said second memory space associated with said first memory space associated with said first software program;
further subsequently transmitting said output to said second memory space associated with said first memory space associated with a second software program;
further subsequently transmitting said output to said first memory space associated with said second software program; and
accessing said output as an input for said second software program;
evaluating whether the outputs of said software programs meet performance criteria;

34. A method for the design and testing of electronic control unit (ECU) software programs, the method comprising:
(a) allocating a plurality of first memory spaces, wherein each software program is associated with one unique said first memory spaces;
(b) allocating a plurality of second memory spaces, wherein each software program's said first memory space is associated with one unique said second memory space.
(c) storing at least one output of at least one first software program in said first memory space associated with that program;
(d) subsequently transmitting said output to said second memory space associated with said first memory space associated with said first software program;
(e) further subsequently transmitting said output to said second memory space associated with said first memory space associated with a second software program;
(f) further subsequently transmitting said output to said first memory space associated with said second software program; and
(g) accessing said output as an input for said second software program;
(h) evaluating the performance of the software programs by determining if the outputs of said software programs meet performance criteria;
(i) rewriting at least a portion of at least one software program if the outputs of any software program do not meet performance criteria, and subsequently repeating steps (a) through (h)
